(19) United States
(12) Patent Application Publication
(10) Pub. No.: US 2018/0084320 A1
(43) Pub. Date: Mar. 22, 2018

(54) PROGRAMMABLE MULTICAST SWITCH

(71) Applicant: Lumentum Operations LLC, Milpitas, CA (US)

(72) Inventors: John MARTINHO, Ottawa (CA); Vlatko MILINKOVIC, Ottawa (CA); Brian SMITH, Ottawa (CA); Peter David ROORDA, Ottawa (CA)

(21) Appl. No.: 15/630,308

(22) Filed: Jun. 22, 2017

Related U.S. Application Data
(60) Provisional application No. 62/397,707, filed on Sep. 21, 2016.

(51) Int. Cl. H04Q 11/00

(52) U.S. Cl. CPC H04Q 11/0005; H04Q 2011/0015; H04Q 11/0003

(57) ABSTRACT

A programmable multicast switch may include a first set of optical ports and a second set of optical ports. The programmable multicast switch may include a plurality of groups of optical devices optically connected in a cascading arrangement. At least one optical device in each of the plurality of groups may be a tunable optical device. Each group may be connected to an optical port of the first set of optical ports. The programmable multicast switch may include a plurality of controllers to tune each corresponding tunable optical devices. The programmable multicast switch may include a processor to control the plurality of controllers. The programmable multicast switch may include a plurality of optical switches connected to each of the groups of optical devices. Each optical switch of the plurality of optical switches may be connected to an optical port of the second set of optical ports.

### RELATED APPLICATION(S)

This application claims priority under 35 U.S.C. § 119 to U.S. Provisional Patent Application No. 62/397,707, filed on Sep. 21, 2016, the content of which is incorporated by reference herein in its entirety.

### TECHNICAL FIELD

The present disclosure relates to optical communications systems. More particularly, the present disclosure relates to a programmable multicast switch to optically split or optically combine laser beams using tunable optical splitters/combiners which enables flexible add/drop structures in colorless, directionless and contentionless (CDC) reconfigurable optical add/drop multiplexer nodes.

### BACKGROUND

A multicast switch may enable colorless, directionless, and contentionless (CDC) switching in a CDC reconfigurable optical add-drop multiplexer (ROADM) node. Colorless switching refers to wavelength flexibility for the ROADM node. In other words, ports of the ROADM node are reconfigurable with regard to wavelength assignment. Directionless switching refers to directional flexibility for the ROADM node. In other words, channel routing assignments of the ROADM node are reconfigurable in any direction from the node. Contentionless switching refers to port flexibility for the ROADM. In other words, multiple ports of add/drop devices in the ROADM node may transmit or receive the same wavelength of light. In such a CDC ROADM node, multiple wavelengths may be switched to multiple fiber directions, and multiple channels utilizing the same wavelength can be concurrently routed between a transmitter/receiver of the ROADM node and a target outgoing/incoming optical fiber coupled to the ROADM node.

A multicast switch (MCS) for a CDC ROADM node may utilize sets of passive optical splitters connected to a set of optical switches which are used to select the ROADM direction addressed by a particular add/drop port of the multicast switch. The quantity of sets of passive optical splitters is associated with the degree (N) of the ROADM. The quantity of individual optical splitter outputs is associated with the number of add/drop ports of the multicast switch. Each set of passive optical splitters/combiners may be constructed using a cascade (e.g., a binary tree) of 1×2 passive optical splitters. Where a set of passive optical splitters is to split an input to more than 4 outputs, corresponding to an add/drop port count greater than 4, the insertion loss of the multicast switch is such that an optical amplifier may be required to recover sufficient optical power at a receiver or ensure sufficient system optical signal to noise ratio (OSNR) on transmit.

Dense wavelength division multiplexed (DWDM) networks are deployed in core and metro optical networks and provide 100 gigabit per second (Gb/s) single carrier wavelength optical communications using coherent polarization multiplexed quadrature phase-shift keying (PM-QPSK). These DWDM networks are being scaled to increasing modulation densities to accommodate 200 Gb/s single carrier and 400 Gb/s single carrier and superchannel implementations to increase capacity from each fiber pair. Additional bands or fiber pairs can be added in the future to increase capacity beyond the optical C-band which will drive higher port count multicast switches to maintain required add/drop capacity. Installing high port count multicast switches at initial deployment requires costly amplifier arrays (e.g. erbium doped amplifier (EDFA) arrays) and in many cases only a fraction of the capacity of the multicast switch may be required at the time of installation. Accordingly, it would be advantageous if a multicast switch with high port count could be deployed initially with no amplifier array to support a low port count requirement and subsequently be reprogrammed at a future date to support a higher port count. Although at some future time, when the multicast switch is reprogrammed for a higher port count, an amplifier array may be required to support a higher insertion loss associated with an increased add/drop capacity; the cost of the amplifier array is deferred until the port capacity is required in the network, thus permitting cost-effective network deployment and subsequent upgrade.

### SUMMARY

According to some possible implementations, an optical divider may include one or more optical inputs. The optical divider may include a plurality of optical outputs. The optical divider may include a planar lightwave circuit having a plurality of optical splitter groups to split optical beams. Each of the plurality of optical splitter groups may be connect to an optical input of the one or more optical inputs. Each of the plurality of optical splitter groups may include an optically connected cascading arrangement of tunable optical splitters. The optical divider may include a plurality of controllers. Each of the plurality of controllers may be to adjust an optical splitting ratio of a corresponding tunable optical splitter of the plurality of optical splitter groups. The optical divider may include a plurality of optical switches to provide optical beam portions of the optical beams for output. Each of the plurality of optical switches may be connected to each of the plurality of optical splitter groups and connected to an optical output of the plurality of optical outputs.

According to some possible implementations, an optical combiner may include a plurality of optical inputs. The optical combiner may include a plurality of optical inputs. The optical combiner may include a planar lightwave circuit having a plurality of optical combiner groups to combine optical beams. Each of the plurality of optical combiner groups may be connected to an optical output of the one or more optical outputs. Each of the plurality of optical combiner groups may include an optically connected cascading arrangement of tunable optical combiners. The optical combiner may include a plurality of controllers. Each of the plurality of controllers may be to adjust an optical combining ratio of a corresponding tunable optical combiner of the plurality of optical combiner groups. The optical combiner may include a plurality of optical switches to receive optical beam portions of the optical beams as input. Each of the plurality of optical switches may be connected to each of the plurality of optical combiner groups and connected to an optical input of the plurality of optical inputs.

According to some possible implementations, a programmable multicast switch may include a first set of optical ports. The programmable multicast switch may include a second set of optical ports. The programmable multicast switch may include a plurality of groups of optical devices optically connected in a cascading arrangement. At least one optical device in each of the plurality of groups may be a tunable optical device. Each group may be connected to an optical port of the first set of optical ports. The programmable multicast switch may include a plurality of controllers to tune each corresponding tunable optical devices. The programmable multicast switch may include a processor to control the plurality of controllers. The programmable multicast switch may include a plurality of optical switches connected to each of the groups of optical devices. Each optical switch of the plurality of optical switches may be connected to an optical port of the second set of optical ports.

### BRIEF DESCRIPTION OF THE DRAWINGS

FIG. 1A is a diagram of a reconfigurable optical add/drop multiplexer (ROADM) node of an optical communications system;

FIG. 1B is a diagram of further components of the ROADM of FIG. 1A;

FIG. 1C is a diagram of a set of 1×2 passive splitters/combiners cascaded to form a 1×N splitter group;

FIG. 1D is a diagram of a 1×32 splitter group with a set of switches within an N×32 multicast switch;

FIGS. 2A and 2B are diagrams of an overview of an example implementation described herein;

FIGS. 3A and 3B are diagrams of a portion of an example implementation of a programmable multicast switch;

FIG. 3C is a table of insertion losses relating to the example implementations described with regard to FIGS. 3A and 3B;

FIGS. 4A and 4B are diagrams relating to another example implementation of a programmable multicast switch; and

FIGS. 5A-5C are diagrams of yet another example implementation of a programmable multicast switch.

### DETAILED DESCRIPTION

The following detailed description of example implementations refers to the accompanying drawings. The same reference numbers in different drawings may identify the same or similar elements.

A dense wavelength division multiplexed (DWDM) optical communications system may include a set of multicast switches to enable colorless, directionless, and contentionless (CDC) reconfigurable optical add-drop multiplexer (ROADM) nodes. A CDC ROADM node may reconfigurably switch a particular wavelength onto a particular fiber in a particular direction and may permit multiple channels with a common wavelength to be routed concurrently between a transmitter or receiver portion of the CDC ROADM node and a target outgoing or incoming optical fiber coupled to the CDC ROAM node. When DWDM optical communications systems approach data capacity limitations on each optical fiber, additional optical fibers are installed to connect CDC ROADM nodes of the DWDM optical communications system, thereby increasing data capacity. Thus, it would be advantageous for CDC ROADMs to include increasing add/drop capacity for the increasing quantities of optical fibers or optical bands that may be installed to increase the achievable optical (data) capacity. In such a scenario, it is advantageous for CDC add/drop devices (i.e., CDC ROADMs) to support higher add/drop capacity in order to prevent unnecessary use of available wavelength selective switch (WSS) line ports.

A multicast switch in a CDC ROADM node may utilize a combination of passive splitters/combiners and optical switches. The number of add/drop ports in the CDC ROADM node relates to the quantity of cascaded 1×2 split/combine elements used to form the passive splitter/combiner. As increasing quantities of 1×2 split/combine elements are cascaded to support a particular quantity of add/drop ports, the insertion loss increases (e.g. in proportion to 10×log 10 (N), where N is the add/drop port count). At some point the amount of insertion loss is so great that amplification (e.g. an erbium doped fiber amplifier (EDFA) array) may be required to compensate for this insertion loss.

Installing amplifiers to compensate for insertion loss created at CDC ROADM nodes is expensive. One way to avoid installing expensive amplifiers is to change the CDC ROADM nodes to use multicast switches with a smaller quantity of ports to reduce insertion loss. However, using more smaller-port-count multicast switches to meet add/drop capacity requirements leads to increased power dissipation, additional equipment footprint and higher wavelength selective switch (WSS) port utilization. These factors cut against the cost savings produced by avoiding installing amplifiers. Accordingly, it would be advantageous to implement a multicast switch in a CDC ROADM node that is programmable to support a high port count with a particular insertion loss, or a smaller port count with a reduced insertion loss. In this way, an initial cost of amplifier arrays may be avoided when the smaller port count is initially required, thereby deferring the cost of amplifiers and avoiding unnecessary exhaustion of WSS line ports.

Implementations, described herein, may provide a programmable multicast switch using a planar lightwave circuit or another type of optical device, such as an optical divider, to provide optical splitting and optical combining. In this way, implementations described herein may enable a more cost effective approach for deploying multicast switches for high port count CDC add/drop devices (e.g., CDC ROADMs), compared with multicast switches based on passive optical splitter/combiners. Moreover, individual optical splitter groups of the optical divider may be tuned to pass or block optical beams, thus enabling a programmable multicast switch for a ROADM node.

Although implementations, described herein may be described in terms of an optical divider with a set of optical splitters, the optical divider may be called an optical combiner when used for optical combining. Similarly, optical splitters may be called optical combiners when used for optical combining. For example, an optical device, described herein in terms of an optical splitter, may, in a first context, operate as a tunable optical splitter of an optical splitter group of an optical divider and may be associated with a particular optical splitting ratio. Additionally, or alternatively, the optical device may, in a second context, operate as a tunable optical combiner of an optical combiner group of an optical combiner and may be associated with a particular optical combining ratio. Thus, although the implementations are described herein in terms of the first context of an optical splitter, the implementations described herein also applies to an optical device operating in the second context as an optical combiner.

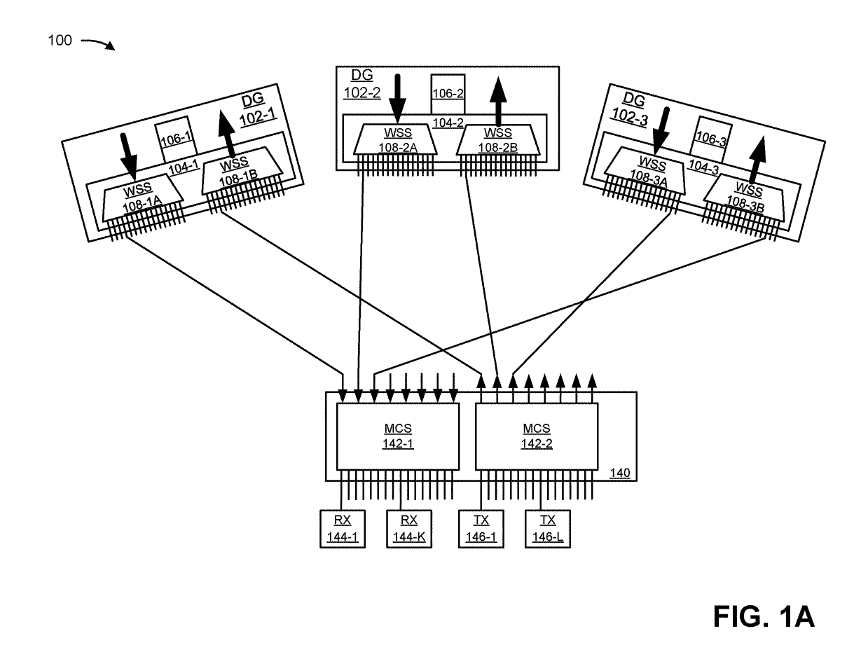

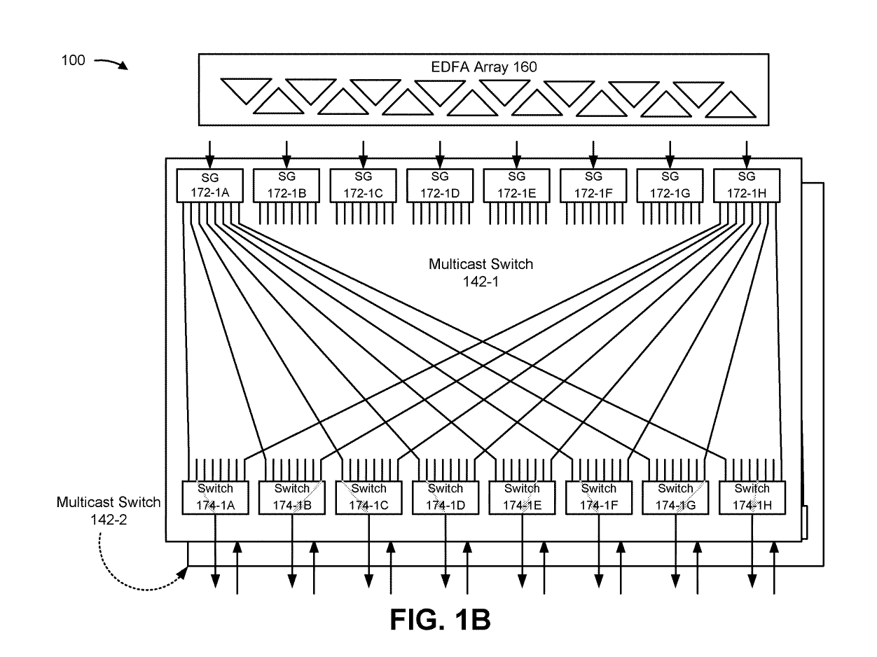

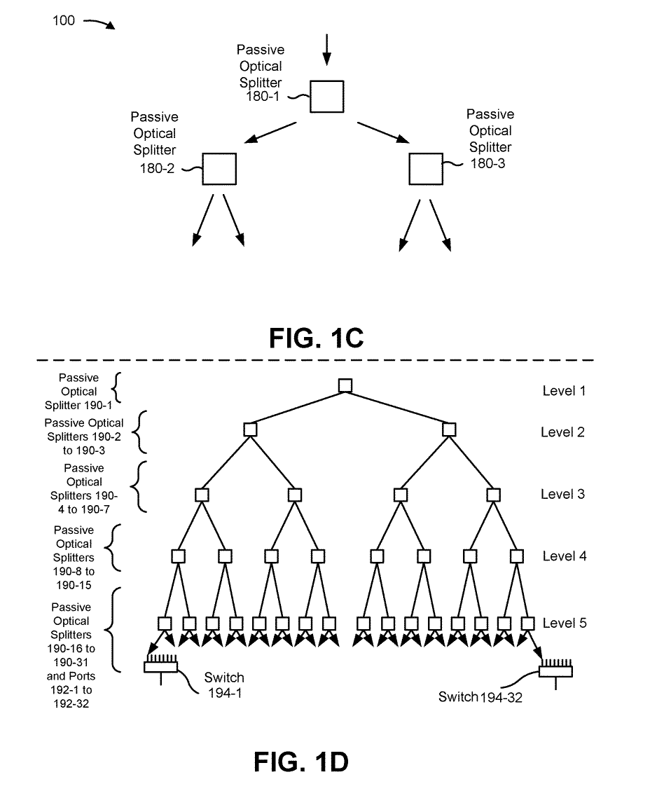

FIGS. 1A and 1B illustrate an example implementation 100 of a ROADM node that includes a multicast switch based on passive optical splitter/combiner and that includes an EDFA array.

As shown in FIG. 1A, example implementation 100 includes a set of degrees 102-1 through 102-3 (hereinafter referred to individually as “degree 102,” and collectively as “degrees 102”), which include a set of multiplexing/demultiplexing stages 104-1 through 104-3 (hereinafter referred to individually as “multiplexing/demultiplexing stage 104,” and collectively as “multiplexing/demultiplexing stages 104”), a set of optical channel monitors 106-1 through 106-3 (hereinafter referred to individually as “optical channel monitor 106,” and collectively as “optical channel monitors 106”), and a set of wavelength selective switches (WSSs) 108-1A through WSS 108-3B (hereinafter referred to individually as “WSS 108,” and collectively as “WSSs 108”).

A degree 102 bidirectionally connects to another ROADM node or an endpoint node of, for example, a DWDM optical communications system. For example, WSS 108-1A may receive a beam from another ROADM node via an optical fiber and provide a wavelength selected portion of the beam to add/drop stage 140, and/or the like. Similarly, WSS 108-1B receives portions of another beam from add/drop stage 140, and/or the like and provides output to the other ROADM node via an optical fiber. Multiplexing/demultiplexing stage 104 may include WSSs 108 and may perform multiplexing of multiple channels corresponding to, for example, multiple wavelengths onto a beam or demultiplexing of multiple channels from a beam using WSSs 108. Optical channel monitor 106 may perform monitoring of one or more channels received by a degree 102.

As further shown in FIG. 1A, example implementation 100 further includes an add/drop stage 140, which includes a set of multicast switches 142-1 through 142-2 (hereinafter referred to individually as “multicast switch 142,” and collectively as “multicast switches 142”), and which optically couples to a set of optical receivers 144 and a set of optical transmitters 146.

Add/drop stage 140 may optically switch a beam from a first optical fiber to a second optical fiber. For example, multicast switch 142-1 may provide a portion of a beam toward each output port RX 144-1 through RX 144-K from WSS 108-1A and may provide a portion of a beam to WSS 108-1B from each input port TX 146-1 through TX 146-L.

In this way, a ROADM node may incorporate a multicast switch to perform switching between different wavelengths or groups of wavelengths to/from a transmitter/receiver in any of the available ROADM directions associated with degrees 102.

As shown in FIG. 1B, example implementation 100 further includes an EDFA array 160 coupled to the multicast switches 142-1 and 142-2 within add/drop stage 140.

Within a multicast switch 142, optical splitter groups 172 broadcast a beam by splitting it into multiple portions, one portion for each output from the multicast switch 142. By splitting the beam into many portions, optical splitter groups 172 significantly reduce the optical power in each beam portion. The more beam portions required, the greater the reduction in optical power in each beam portion and by corollary, the greater the insertion loss.

EDFA array 160 may amplify the beams provided to the optical splitter groups 172, as shown, or may amplify the beam portion output by switches 174. Alternatively, EDFA array 160 may be integrated into the ROADM node in other ways. EDFA array 160 includes an amplifier for each degree port of each multicast switch 142 in the ROADM node. EDFA array 160 is provided to compensate for optical power loss (such as from optical splitter groups 172 and/or switches 174).

In FIG. 1B, multicast switches 142 have fewer ports than in FIG. 1A for illustrational simplicity. Multicast switches 142 operate in a broadcast-and-select architecture. Multicast switch 142-1 includes an optical splitter group 172-1A through 172-1H for each input. Each optical splitter group 172 is coupled to each of a set of switches 174-1A through 174-1H. Multicast switch 142-1 may receive beams directed from a ROADM degree, such as the ROADM degree 102-1 shown in FIG. 1A. Similarly, multicast switch 142-2 may provide beams directed to the ROADM degree, such as degree 102-1 shown in FIG. 1A

Each switch 174 receives a beam portion from each optical splitter group 172. Each switch 174 includes a selector to select which beam portion is provided as output. For example, switch 174-1A may select to provide a beam portion received as input from optical splitter group 172-1A as output from switch 174-1A. Similarly, switch 174-1B may select to provide a beam portion received as input from optical splitter group 172-1H as output from switch 174-1B. In this broadcast-and-select architecture, splitting each beam into many portions and subsequently selecting just one beam portion for each output creates significant insertion loss. This insertion loss increases as the quantity of add/drop ports increases.

As an example, a 16 add/drop port multicast switch 142 may introduce, for example, 13 dB insertion loss from optical splitter groups 172 and 4 dB insertion loss from switches 174, resulting in a total insertion loss of 17 dB. In another example, a 32 add/drop port multicast switch 142 may result in a total insertion loss of, for example, 21 dB. In another example, a 64 add/drop port multicast switch may result in a total insertion loss of, for example, 24 dB. Thus, as add/drop port count increases, a more powerful amplifier array is required to compensate for increased insertion losses. Including EDFA array 160 may increase overall node cost, power dissipation, and footprint required of a ROADM node that includes multicast switch 142.

As shown in FIG. 1C, an optical splitter group 172 of example implementation 100 may include a set of 1×2 passive optical splitters 180-1 through 180-3 in a cascading arrangement (i.e., passive optical splitter 180-1 connects to passive optical splitters 180-2 and 180-3, which may each further connect to other passive optical splitters 180 to provide a required quantity of beam portions from optical splitter group 172). In some implementations, passive optical splitters 180 may correspond to a set of optical splitters included in optical splitter group 172 (e.g., a cascading arrangement of 1×2 optical splitters enabling a 1×8 optical splitter). An optical beam input to passive optical splitter 180-1 is split statically (e.g., a fixed 50-50 split) and broadcast to passive optical splitters 180-2 and 180-3. Each of passive optical splitters 180-2 and 180-3 further broadcasts equal portions of the optical beam to subsequent passive optical splitters 180 (not shown), ports, and/or the like. In this case, each passive optical splitter 180 may introduce, for example, a 3 dB insertion loss; thus, cascading several levels of passive optical splitters 180 increases insertion loss.

As shown in FIG. 1D, a 1×32 optical splitter group 172 of example implementation 100 may be implemented as a set of 1×2 passive optical splitters 190-1 through 190-31 arranged in a binary tree. The binary tree ends with a set of ports 192 (hereinafter referred to individually as “port 192,” and collectively as “ports 192”). Each port 192 of the 1×32 optical splitter group 172 is connected to a different switch 194 of the set of switches 194-1 through 194-32. As another example, for an 8×32 multicast switch, there would be 8 1×32 optical splitter groups 172, with each 1×32 optical splitter group 172 receiving one input that is split into 32 portions, and 32 8×1 switches 194, with each 8×1 switch 194 receiving a portion from each 1×32 optical splitter group 172.

In operation, an optical beam input at a first level to passive optical splitter 190-1 is optically split and broadcast to passive optical splitters 190-2 and 190-3 at a second level. The portions of the optical beam input to passive optical splitters 190-2 and 190-3 are split and broadcast to passive optical splitters 190-4 through 190-7 at a third level, 190-8 through 190-15 at a fourth level, and 190-16 through 190-31 at a fifth level. At each level, the number of beam portions doubles and an additional 3 dB of insertion loss is introduced into each portion of the optical beam, which necessitates use of an amplifier array, as shown in FIG. 1B. Thus, it is advantageous to provide a programmable splitter allowing a user to select fewer add/drop ports for an initial implementation which may eliminate the need for an EDFA array until a subsequent time when additional add/drop capacity is required.

As indicated above, FIGS. 1A-1D are provided merely as examples. Other examples are possible with different port counts and may differ from what was described with regard to FIGS. 1A-1D.

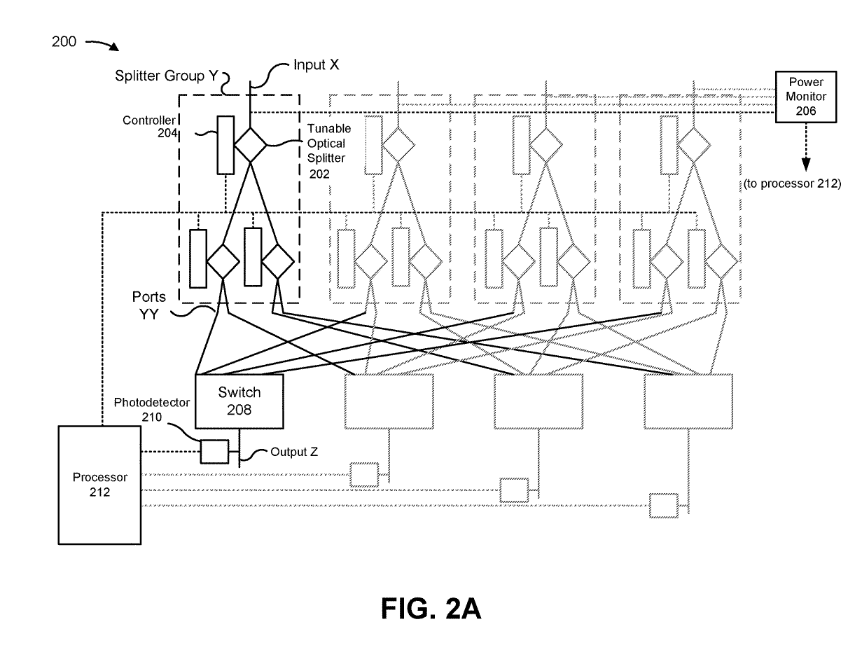

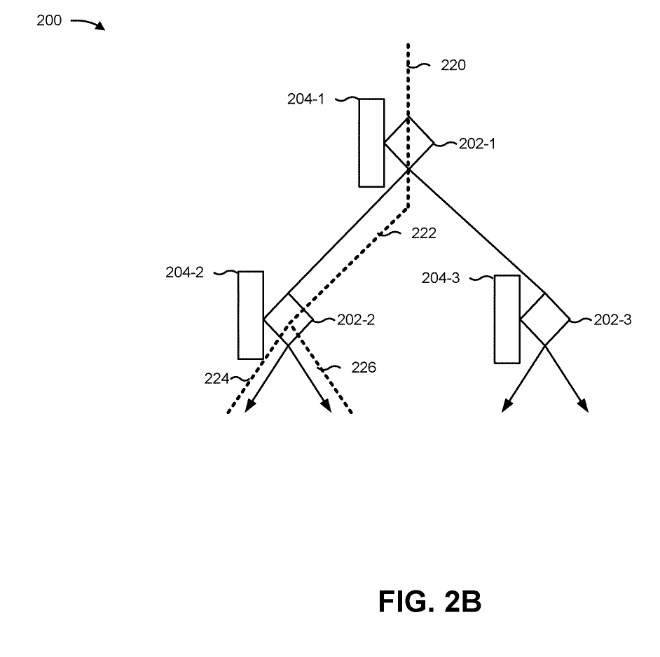

FIGS. 2A and 2B are diagrams of an example programmable multicast switch 200 described herein. The example programmable multicast switch 200 in FIG. 2A is reduced in port count for ease of illustration and explanation, but higher port count multicast switches can be readily understood from this example. As shown in FIG. 2A, programmable multicast switch 200 provides an example 4×4 programmable multicast switch. There are four optical inputs X (hereinafter referred to individually as “input X” and collectively as “inputs X”) and four optical outputs Z (hereinafter referred to individually as “output Z” and collectively as “outputs Z”). Each input X is connected to a corresponding one of four splitter groups Y (hereinafter referred to individually as “splitter group Y” and collectively as “splitter groups Y”) and a port from each splitter group Y connects to each of four switches 208 (hereinafter referred to individually as “switch 208” and collectively as “switches 208”). In this example 4×4 programmable multicast switch 200, each splitter group Y may split an optical beam from the input X into up to four beam portions. Each splitter group Y includes a set of tunable optical splitters 202 (hereinafter referred to individually as “tunable optical splitter 202,” and collectively as “tunable optical splitters 202”), a set of controllers 204 (hereinafter referred to individually as “controller 204,” and collectively as “controllers 204”) and a set of ports YY (hereinafter referred to individually as “port YY” and collectively as “ports YY”). Each tunable optical splitter 202 may split the beam or portion it receives into two portions. The tunable optical splitters 202 of FIG. 2A are binary splitters optically connected in a binary tree, but other size splitters and other cascading arrangements are also possible. With three tunable optical splitters 202 in the splitter group Y forming two levels of a binary tree, an input optical beam may be split into four portions, with one portion provided to each port YY.

As further shown in FIG. 2A, a controller 204 is connected to each tunable optical splitter 202 in the splitter group Y for tuning a splitting ratio of the tunable optical splitter 202. Tuning the splitting ratio allows adjustment of the percentage of light or power from the optical beam that is provided on each of the outputs from the tunable optical splitter 202. A controller 204 may tune a tunable optical splitter 202 to split the optical beam in a selected ratio (e.g., from 0/100, which may refer to an apportionment of 0% of the light or power from the optical beam being provided to a first output and 100% of the light or power from the optical beam being provided to a second output, to 100/0). Moreover, controller 204 may enable the selected ratio to be adjusted, dynamically. This is in contrast to conventional 1×2 passive optical splitters, described in FIGS. 1C and 1D for example, which may have a fixed splitting ratio (e.g., a 50/50 splitting ratio).

As further shown in FIG. 2A, each port YY from the splitter group Y is connected to a different switch 208. In this case, there are four switches 208 corresponding to the four splitter groups Y and the four inputs X of the example programmable multicast switch 200 of FIG. 2A. Each of the four switches 208 receives a beam portion from each of the four splitter groups Y. Accordingly, each switch 208 may be controlled by processor 212 to select a beam portion from any of the inputs X to be provided to any output Z of the programmable multicast switch 200.

As further shown in FIG. 2A, the programmable multicast switch 200 may also include a power monitor 206, a set of photodetectors 210 (hereinafter referred to individually as “photodetector 210,” and collectively as “photodetectors 210”), and the processor 212.

The processor 212 is connected to the controllers 204, and may receive data from and/or control the controllers 204. Similarly, the processor 212 may be connected to the power monitors 206 and/or the photodetectors 210, and may receive data from and/or control the power monitors 206 and/or the photodetectors 210. When the processor 212 instructs the controllers 204 to tune all tunable optical splitters 202 to split light 50/50, each splitter group Y splits its corresponding input X optical beam equally to each switch 208 yielding approximately a 6 dB loss in each sub beam. In this case, the programmable multicast switch is considered fully provisioned (e.g. all add/drop ports are in use). Alternatively, and as illustrated in FIG. 2B, if the processor 212 instructs the controllers 204 of the first tunable optical splitter 202 of each splitter group Y to split light 100/0 (e.g. an apportionment of 100% of input light to the left output and 0% of input light to the right output) and all other controllers 204 remain at 50/50, then each splitter group Y splits its input X optical beam equally to the first two switches 208 (with approximately 3 dB loss in each beam portion) and the input X optical beam is blocked from the last two switches 208. In this configuration, the 4×4 programmable multicast switch 200 may be termed under-provisioned (e.g. some add/drop ports are unused in this configuration and could be available for use at a future date) but the insertion loss has been reduced. The 4×4 programmable multicast switch 200 has been configured to operate as a 4×2 programmable multicast switch with reduced loss. In this way, a programmable multicast switch with a high quantity of degrees (e.g., a quantity of degrees that exceeds a threshold to require amplifiers, such as 8×32) can be deployed, without amplifiers, but configured to operate at a low degree (e.g., a degree that does not exceed a threshold to require amplifiers, such as 8×4). Then, at another time amplifiers can be deployed, thereby providing a benefit of deferring cost, and the programmable multicast switch 200 can be reconfigured to operate at the higher degree using the amplifiers.

Although described herein in terms of a programmable multicast switch 200 that include inputs X and outputs Z, the inputs X and outputs Z may be referred to more generally as ports or add/drop ports. When an optical beam is travelling in an opposite direction, the inputs X may be outputs and the outputs Z may be inputs. Although described herein in terms of each splitter group Y including a set of tunable optical splitters 202, the tunable optical splitters 202 may be referred to, interchangeably, as optical dividers. The term “divider” may be used interchangeably with “splitter” or “combiner”. Thus, the terms “splitter” and “combiner” should not be construed to indicate a required directionality, but only to identify a directionality that is depicted in a corresponding figure as an example; and should not be understood to be limiting as to the directionality that is possible for implementations depicted in the corresponding figure. Thus, an implementation described as an optical splitter may be used in an optical combining direction, an implementation described as an optical combiner may be used in an optical splitting direction. For example, in FIGS. 2A and 2B, optical splitters 202 in each splitter group Y may be optically connected to split an input to a plurality of outputs, and may also be combiners to combine a plurality of inputs to a single output depending on the direction light is traveling, and may be described as optical splitters (202), optical combiners (202), or optical dividers (202) interchangeably.

The optical dividers may be interconnected in a binary tree (where the optical splitters have a 1:2 ratio), other K-ary tree, or another regular or irregular cascaded arrangement. An optical divider can be an optical splitter and/or an optical combiner (e.g. tunable optical divider 202) and can operate in the transmit direction, the receive direction, or both the transmit direction and the receive direction. Thus, although implementations, described herein, may be described in terms of an optical splitter, implementations described herein may also operate and as an optical combiner.

Tunable optical divider 202 includes an optical splitter and/or an optical combiner with a tunable optical splitting ratio. For example, tunable optical divider 202 may include a thermally tunable optical divider, an electrically tunable optical divider, an acoustically tunable optical divider, a magnetically tunable optical divider, and/or another type of tunable optical splitter or tunable optical combiner. In some implementations, tunable optical divider 202 may receive a beam and may optically split the beam to multiple paths. In some implementations, tunable optical divider 202 may combine multiple paths into a single optical path. In some implementations, tunable optical divider 202 may split to, or combine from, more than two paths. In some implementations, tunable optical divider 202 may be implemented in a planar lightwave circuit. In some implementations, tunable optical divider may be implemented in other technologies, such as using silicon photonics, discrete components, or the like.

In some implementations, tunable optical divider 202 may block a beam. For example, as shown in FIG. 2B, tunable optical divider 202-1 may be controlled by controller 204-1 such that an optical beam is directed to (only) one of two outputs of tunable optical divider 202-1 toward tunable optical divider 202-2, effectively blocking the other path (output) of tunable optical divider 202-1 toward tunable optical divider 202-3. In some implementations, tunable optical divider 202 may be included in an optical splitter group (or an optical combiner group). For example, an optical splitter group may include a cascading arrangement (e.g. a K-ary tree) of tunable optical dividers 202, as shown in FIG. 2B, that receive a beam from an optical input, optically split the beam, and provide portions of the optically split beam to a set of optical switches 208. In some implementations, tunable optical divider 202 may be tuned by, or may use a control signal from, controller 204 to control the optical splitting ratio individually for each tunable optical divider 202. In this case, tunable optical divider 202 optically couples to an optical input of an optical switch 208.

Controller 204 includes a control element corresponding to tunable optical divider 202. For example, controller 204 may include a thermal controller to thermally tune a thermally tunable optical divider 202, to electrically tune an electrically tunable optical divider 202, to acoustically tune an acoustically tunable optical divider 202, to magnetically tune a magnetically tunable optical divider 202, and/or the like. Additionally, or alternatively, controller 204 may include a different type of controller to tune a different type of tunable optical divider 202. In some implementations, each controller 204 may control a corresponding tunable optical divider 202. For example, a first controller 204 may control a first tunable optical divider 202 and a second controller 204 may control a second tunable optical divider 202. In some implementations, a single controller 204 may control multiple tunable optical dividers 202. In some implementations, controller 204 may be implemented in a planar lightwave circuit but other technology implementations are also possible.

Power monitor 206 includes an optical power monitor to monitor optical powers of individual wavelengths, wavelength channels or wavelength ranges of a beam. Power monitor 206 may monitor optical powers of the inputs X simultaneously or sequentially. In some implementations, power monitor 206 may provide information identifying an optical power, per input X and/or per wavelength, to processor 212. For example, power monitor 206 may indicate an input optical power of a particular wavelength of a particular beam input to a particular tunable optical divider 202, and processor 212 may transmit a control signal to controller 204 to control an attenuation of the particular tunable optical divider 202 to control an optical power of a beam portion. In this case, programmable multicast switch 200 permits optical power at a set of add/drop ports addressable by any degree to be varied by adjusting the optical splitting ratio of tunable optical dividers 202. In this way, programmable multicast switch 200 permits an add/drop device to adjust optical power at a receiver in the event that there is insufficient dynamic range available on a WSS for attenuation of a beam.

Switch 208 includes an M×1 optical switch (M>1) to select an optical beam received from a particular splitter group Y for output. For example, switch 208 may include a selector switch to select a particular optical beam portion from a particular tunable optical divider 202 to be provided as output at a single add/drop port. If operating as a combiner, switch 208 may receive an optical beam portion from an optical input and provide the particular optical beam portion as input to a particular tunable optical divider 202 for combining with other optical beam portions from other optical switches 208. In some implementations, switch 208 may be implemented in a planar lightwave circuit but other technology implementations are also possible.

Photodetector 210 includes a photodetector or an array of photodetectors 210 to monitor an optical power of an output Z of the programmable multicast switch 200. In some implementations, photodetector 210 may provide information identifying value of optical power of a beam on a per wavelength and/or per port basis to processor 212 to enable processor 212 to generate a control signal, or a set of control signals, to transmit to controllers 204 to control attenuation by tunable optical dividers 202.

Processor 212 is implemented in hardware, firmware, or a combination of hardware and software. Processor 212 may be a central processing unit (CPU), a graphics processing unit (GPU), an accelerated processing unit (APU), a microprocessor, a microcontroller, a digital signal processor (DSP), a field-programmable gate array (FPGA), an application-specific integrated circuit (ASIC), or another type of processing component. In some implementations, processor 212 includes one or more processors capable of being programmed to perform a function. For example, processor 212 may receive user input from an external system which identifies set points of the controllers 204 (e.g. a splitting ratio or combining ratio) to configure a sub-set of the add/drop ports to be enabled or disabled or to configure their respective insertion losses.

As shown in FIG. 2B, an optical splitter group may include a set of tunable optical dividers 202 in a cascading arrangement (e.g. a binary tree). Controllers 204-1, 204-2, and 204-3 are coupled (e.g., thermally, electrically, or the like) to tunable optical dividers 202-1, 202-2, and 202-3, respectively. In response to a control signal, controller 204-1 can influence tunable optical divider 202-1 to have a particular optical splitting ratio (e.g. 100/0) that blocks optical path 220 splitting to tunable optical divider 202-3. In practice, a small amount of loss may be incurred along a selected path when attempting to block the optical path 220 splitting to tunable optical divider 202-3; however, the majority of a beam would follow optical path 222, reducing insertion loss substantially when compared to a passive optical splitter 180. As shown, an optical path at the input of tunable optical divider 202-1 can be directed towards tunable optical divider 202-2, while the optical path towards tunable optical divider 202-3 is blocked. This may result in an optical path 220, 222, 224, 226. In this case, a beam following optical path 220, 222, 224 or 220, 222, 226 through tunable optical dividers 202-1 and 202-2 will experience an insertion loss of only 3.5 dB while the insertion loss of the passive optical splitter group shown in FIG. 1C would be 6 dB.

As indicated above, FIGS. 2A and 2B are provided merely as examples. Other examples with different split ratios (e.g. 90/10) and different numbers of inputs, outputs, splitter groups, switches, etc. are possible and may differ from what was described with regard to FIGS. 2A and 2B.

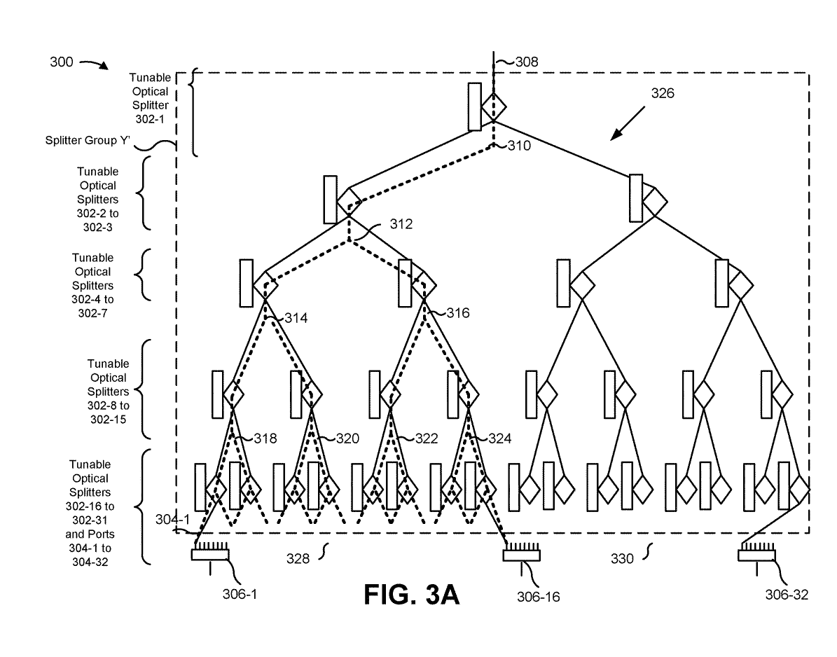

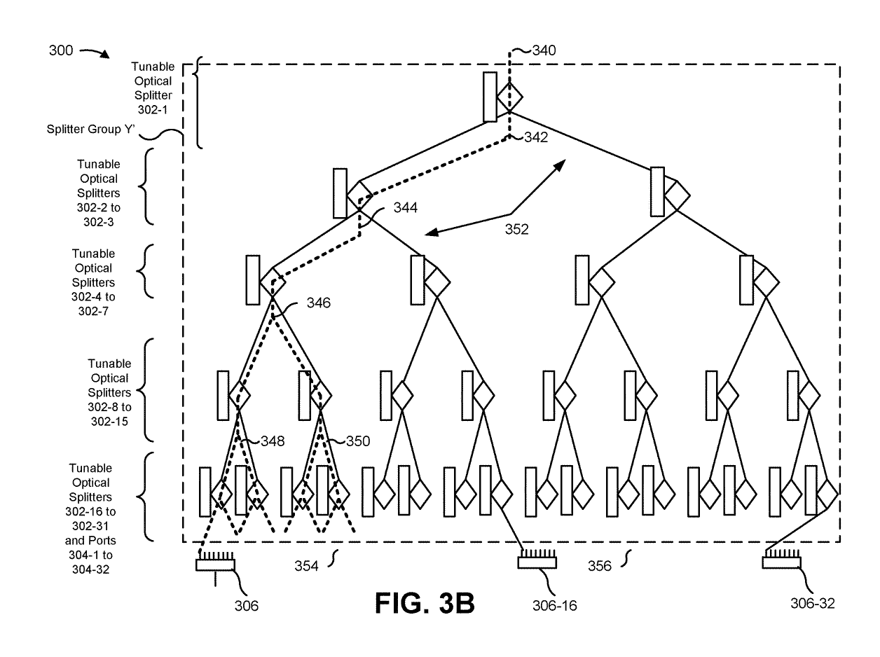

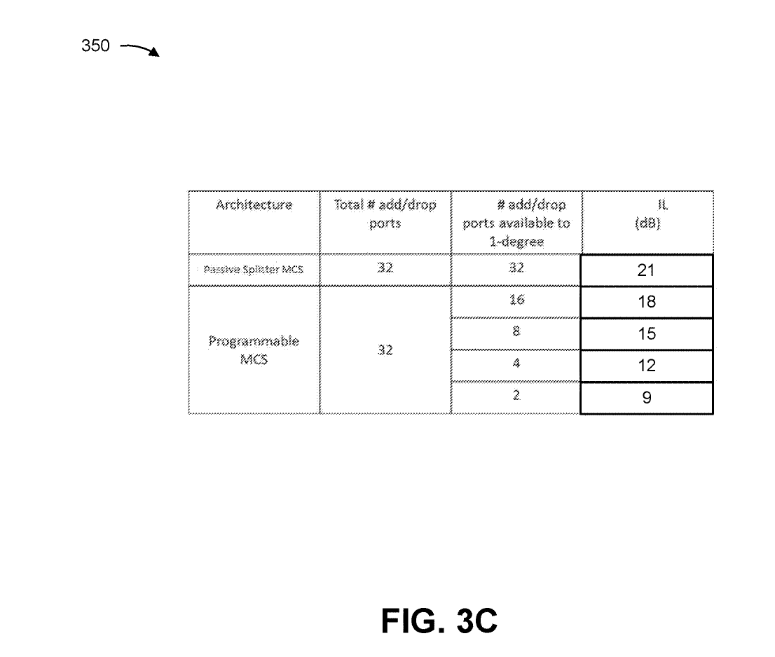

FIGS. 3A-3B are diagrams of portions of an example implementation of a programmable multicast switch 300. FIGS. 3A and 3B show an example splitter group Y′ capable of splitting an input into up to 32 portions. The splitter group Y′ has a cascading arrangement (e.g. a full depth-5binary tree) of tunable optical splitters 302 for one input to the programmable multicast switch 300. Not illustrated are any further inputs and their corresponding splitter groups Y′. An output from each of the splitter groups Y′ is connected to each switch 306, which selects a beam portion from one of the splitter groups Y′ for output from the programmable multicast switch 300. Not illustrated are the other switches 306 similarly connected to receive one beam portion from each of the other splitter groups Y′ to provide the other outputs of the programmable multicast switch 300.

As shown in FIG. 3A, programmable multicast switch 300 includes a splitter group Y′ having a set of cascaded 1×2 tunable optical splitters 302-1 through 302-31 (and corresponding controllers), a set of ports 304-1 through 304-32, and a set of switches 306 (e.g., M×1 switches) to form an M×32 programmable multicast switch. Programmable multicast switch 300 may include multiple splitter groups Y′ associated with multiple inputs of programmable multicast switch 300—a single splitter group Y′ is shown for simplicity. In the configuration illustrated in FIG. 3A, an optical coupling ratio for each tunable optical splitter 302 is configured (e.g. by respective controllers) to enable half (16) of the available ports 304 and block half of the available ports 304. This causes programmable multicast switch 300 to be programmed as an M×16 multicast switch, where M is a quantity of ROADM degrees to which programmable multicast switch 300 is couplable. The quantity of degrees to which programmable multicast switch 300 is couplable corresponds to a quantity of optical splitter groups Y′ of programmable multicast switch 300. For example, if programmable multicast switch 300 includes eight 1×32 optical splitter groups Y′, and 32 associated 8×1 optical switches 306, the device represents an 8×32 programmable multicast switch coupable to 8 degrees of add/drop in a ROADM node.

Returning to the example illustrated in FIG. 3A where programmable multicast switch 300 is programmed as an M×16 multicast switch, there could be an insertion loss of, for example, 13 dB associated with tunable optical splitters 302 and 5 dB associated with switches 306, resulting in a total insertion loss of 18 dB. In contrast, an M×32 multicast switch with passive optical splitters would have a total insertion loss of 21 dB. Thus, when fewer than 16 or fewer of 32 ports are required, utilizing tunable optical splitters 302 to block ports of programmable multicast switch 300 reduces insertion loss relative to a passive optical splitter based multicast switch with a fixed set of 32 ports.

As further shown in FIG. 3A, the set of controllers may tune tunable optical splitters 302-1 through 302-31 to a particular optical splitting ratio to cause the M×N programmable multicast switch 300 to be an M×16 (e.g., an 8×16) multicast switch. For example, based on an optical coupling ratio of tunable optical splitter 302-1 blocking an output port of tunable optical splitter 302-1 toward tunable optical splitter 302-3, programmable multicast switch 300 is configured to have an active optical path via 310, 312, 314, 316, 318, 320, 322, and 324 through the splitter cascade. As shown by reference number 326, other tunable optical splitters 302 are blocked from passing any portion of a beam via another optical path. As shown by reference number 328, optical path 308-324 results in ports 304-1 to 304-16 receiving beam portions and being selectable by switches 306-1 through 306-16 for add/drop by programmable multicast switch 300. As shown by reference number 330, ports 304-17 to 304-32 are not passed portions of a beam.

As shown in FIG. 3B, the set of controllers may tune tunable optical splitters 302-1 through 302-31 to configure only 8 of the total 32 add/drop ports to pass portions of an optical beam resulting in an M×8 multicast switch arrangement (e.g., an 8×8 programmable multicast switch). For example, based on an optical coupling ratio of tunable optical splitters 302-1 and 302-2 blocking output ports of tunable optical splitters 302-1 and 302-2, respectively, programmable multicast switch 300 is configured to allow an optical path through 340, 342, 344, 346, 348, and 350 through the splitter cascade. As shown by reference number 352, other tunable optical splitters 302 of another optical path are blocked from receiving portions of an optical beam. As shown by reference number 354, optical path 340-350 results in ports 304-1 to 304-8 being available for switches to select a beam portion for add/drop by programmable multicast switch 300. As a result, tunable optical splitters 302 in optical path 340-350 are associated with introducing, for example, 10 dB of insertion loss, resulting in a total insertion loss of 15 dB, thereby further reducing insertion loss when 8 of the 32 ports are needed. In contrast, as shown by reference number 356, other optical paths result in ports 304-9 through 304-32 being unavailable for switches to select a beam portion for add/drop by programmable multicast switch 300.

In this way, programmable multicast switch 300 may be dynamically adjusted to match a quantity of ports that are actually required for add/drop capacity at a ROADM node and can be reconfigured to make full capacity available. The cost of the EDFA array can therefore be deferred until when greater port capacity may be required. Additionally, this configuration avoids exhausting WSS line ports as would be the case if smaller capacity multicast switches are used to scale add/drop ports over time.

As shown in FIG. 3C, example diagram 350 includes characteristics of a programmable multicast switch (e.g., programmable multicast switch 200, programmable multicast switch 300, and/or other implementations described herein) relative to a passive optical splitter based multicast switch.

As further shown in FIG. 3C, a passive optical splitter based multicast switch with a total of 32 add/drop ports is associated with an fixed insertion loss of 21 dB, regardless of the quantity of add/drop ports being used to support a particular ROADM node configuration. In contrast, for a programmable multicast switch with a total 32 add/drop ports, if only 16 ports are required in a particular configuration, the insertion loss would reduce to 18 dB. For a configuration providing 8 ports to each degree, the loss further reduces to 15 dB. If a configuration reduces the available port count to 4 or 2 available to any degree, the insertion loss of the device can be reduced to 12 dB and 9 dB, respectively. In these examples, the programmable multicast switch reduces the available ports by controlling particular tunable optical splitters to block particular optical paths. Thus, as shown, in scenarios where the programmable multicast switch is configured for fewer than 32 ports per degree, the programmable multicast switch may be tuned to reduce insertion loss relative to the passive optical splitter based multicast switch. In this case, the programmable multicast switch may obviate a need for an EDFA array or reduce a size of an EDFA array, thereby reducing the initial investment required in the network infrastructure.

Although implementations described herein are described in terms of an optical splitter group with cascading arrangement of tunable optical splitters of an M×N programmable switch (e.g., where M is a quantity of inputs, such as 1, 2, 4, 8, 16, 32, 64, and/or the like and N is a quantity of outputs, such as 1, 2, 4, 8, 16, 32, 64, and/or the like), another type of arrangement may be used for another desired quantity of add/drop ports, another desired output power of add/drop ports, and/or the like.

As indicated above, FIGS. 3A-3C are provided merely as examples. Other examples are possible and may differ from what was described with regard to FIGS. 3A-3C.

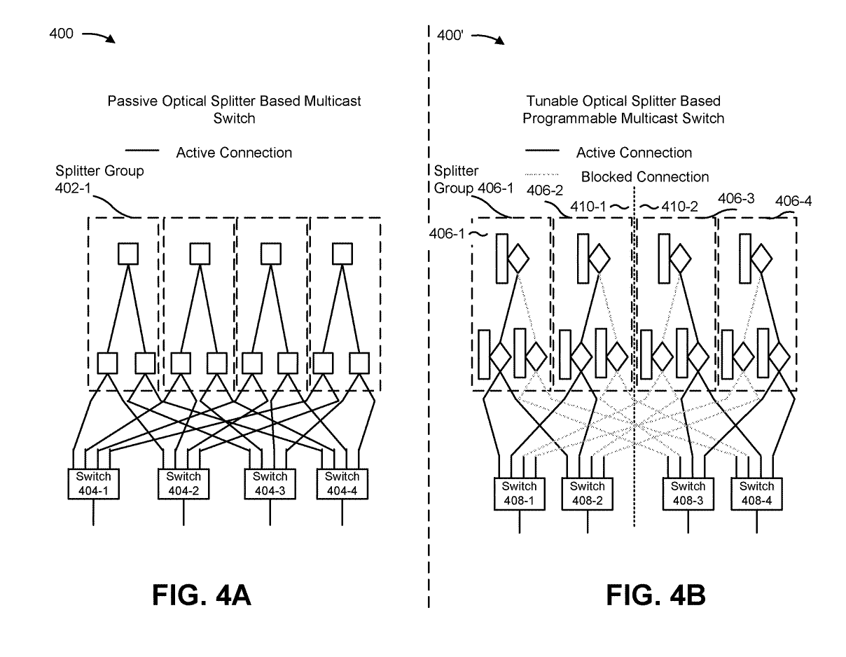

FIGS. 4A and 4B are diagrams of example implementations 400/400′ of a passive optical splitter based multicast switch and a tunable optical splitter based programmable multicast switch, respectively. FIG. 4B shows examples relating to the programmable multicast switch.

As shown in FIG. 4A, multicast switch 400 includes passive splitter groups 402, which each include passive optical splitters in a cascading arrangement and coupled to switches 404. In this case, each connection of passive splitter based multicast switch 400 splits an incoming beam 50/50, thus resulting in every switch 404 receiving a beam portion from every degree and resulting in switches 404 being used to select portions of a beam from a particular degree. Moreover, multicast switch 400 is fixed as a 4×4 multicast switch with an insertion loss of approximately 9 dB.

As shown in FIG. 4B, programmable multicast switch 400′ includes tunable optical splitter groups 406, which each include tunable optical splitters in a cascading arrangement, coupled to a set of switches 408. Although programmable multicast switch 400′ is configured in a similar cascading arrangement to passive splitter based multicast switch 400 and, thus, may operate as a 4×4 multicast switch, programmable multicast switch 400′ may also operate in another configuration based on tuning optical splitters of splitter group 406. For example, tunable optical splitters of splitter groups 406 may be tuned to block an optical path through a respective sequence of tunable optical splitters in a splitter group 406 and out to a switch 408. In some implementations, a processor of programmable multicast switch 400′ may generate a control signal to tune subsets of tunable optical splitters of a splitter group 406. For example, as shown by reference number 410-1, tunable optical splitters of splitter groups 406-1 and 406-2 may block optical paths to switches 408-3 and 408-4 from their respective splitter groups. As shown by reference number 410-2, tunable optical splitters of splitter groups 406-3 and 406-4 may block optical paths to switches 408-1 and 408-2 from their respective splitter groups.

In this way, programmable multicast switch 400′ may be reconfigured from a 4×4 multicast switch (e.g., when no ports are blocked) to two 2×2 multicast switches, each with an insertion loss of ˜6 dB. In this case, the two 2×2 multicast switches provide, for a network, a first multicast switch with inputs to splitter groups 406-1 and 406-2, an optical path from splitter groups 406-1 and 406-2 to switches 408-1 and 408-2, and outputs from switches 408-1 and 408-2 and a second multicast switch with inputs to splitter groups 406-3 and 406-4, an optical path from splitter groups 406-3 and 406-4 to switches 408-3 and 408-4, and outputs from switches 408-3 and 408-4. So configured, the two 2×2 multicast switches would be independently operable. Similarly, a 16×32 programmable multicast splitter may be reconfigured as two independently operable 8×16 multicast splitters, four independently operable 4×8 multicast splitters, etc. so that the 16×32 programmable multicast splitter can be used for a 16 degree ROADM, an 8 degree ROADM, a 4 degree ROADM, and/or the like. In this way, a single programmable multicast switch may be configured to form multiple smaller (in terms of ports) multicast switches using the same hardware, thereby improving network flexibility and reducing the operational cost of deploying multiple device variants within a network.

As indicated above, FIGS. 4A and 4B are provided merely as examples. Other examples are possible and may differ from what was described with regard to FIGS. 4A and 4B.

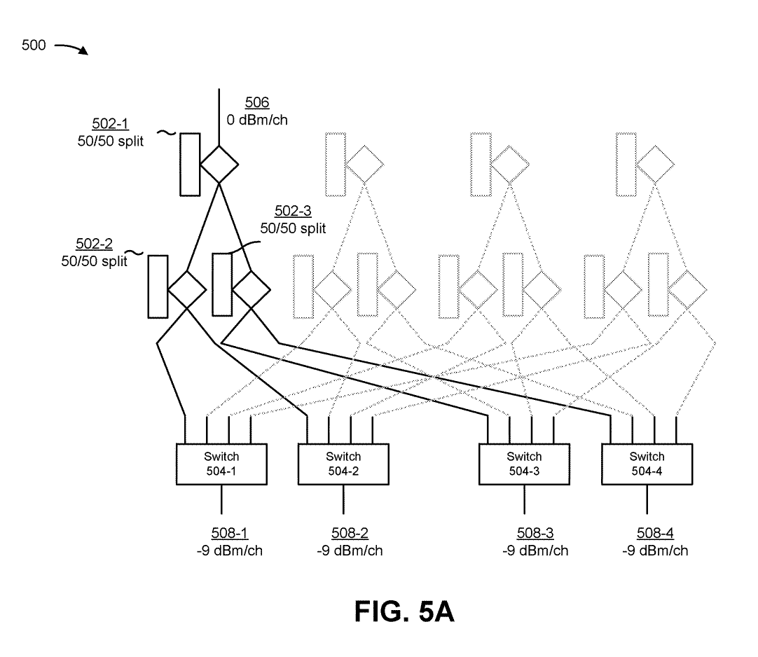

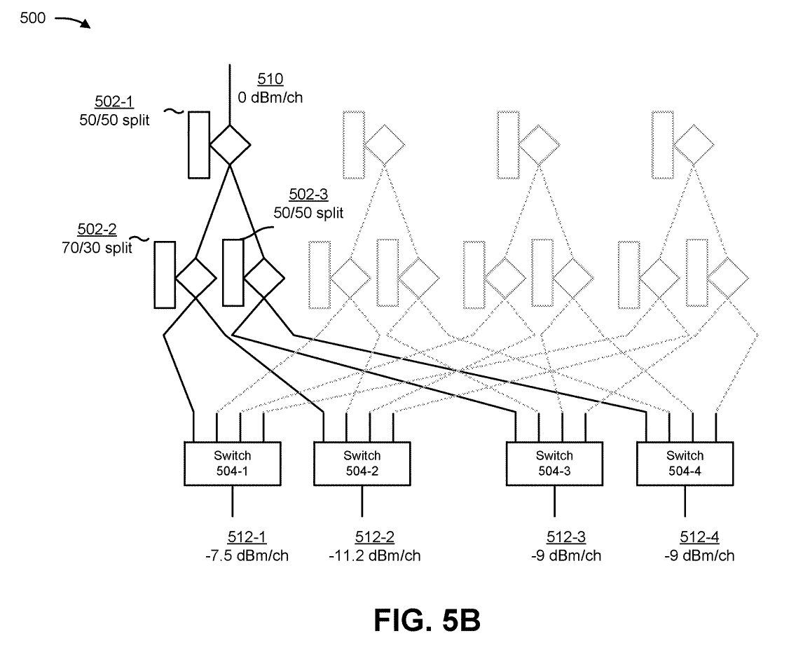

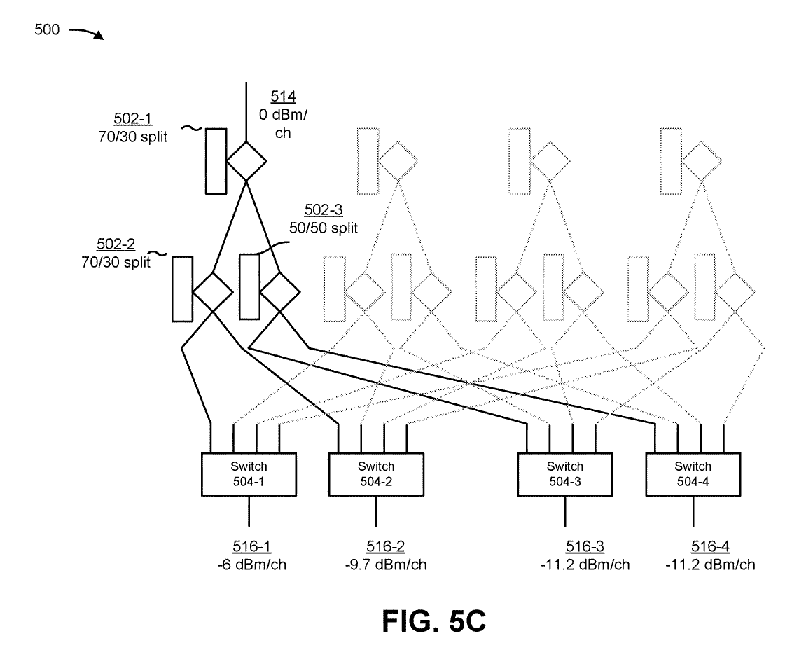

FIGS. 5A-5C are diagrams of a programmable multicast switch 500 and show an embodiment of the invention where the tunable optical splitters can be used to provide programmable attenuation through the device. As shown in FIG. 5A, programmable multicast switch 500 includes tunable optical splitters 502 (of a set of splitter groups) and associated controllers coupled to a set of switches 504 from each input. As an example, tunable optical splitters 502-1, 502-2, 502-3, etc. can be configured with a 50/50 optical splitting ratio and switches 504-1 through 504-4 can be configured to select a corresponding input from the cascade of tunable optical splitters 502-1, 502-2 and 502-3. Under these conditions the optical loss experienced through each of the tunable optical splitters is approximately 3 dB, while the optical loss experienced through each switch is approximately 3 dB. For an incident optical power of 0 dBm at input 506, the optical power received at each drop port of switches 504-1 through 504-4 is −9 dBm, as shown by reference numbers 508-1 through 508-4. In this way, programmable multicast switch 500 provides a common, nominal optical output power from each of the ports of switch 504.

A further example is shown in FIG. 5B where tunable optical splitter 502-2 can be reconfigured with a 70/30 optical splitting ratio (i.e., an apportionment of 70% of the optical power from the input is distributed to switch 504-1 and 30% of the optical power from the input is incident on switch 504-2). Tunable optical splitters 502-1 and 502-3 are configured to maintain a 50/50 optical splitting ratio. Under this configuration, the optical loss experienced through the tunable optical splitters 502-1 and 502-3 with a 50/50 splitting ratio is approximately 3 dB, while the optical loss experienced through tunable optical splitter 502-2 with a 70/30 splitting ratio is approximately 1.5 dB for the 70% port and approximately 5.2 dB for the 30% port. The loss through each of the switches 504 is approximately 3 dB. For an incident optical power of 0 dBm at input 510, the output power from switch 504-1 is −7.5 dBm while the output power from switch 504-2 is −11.2 dBm, as shown by reference numbers 512-1 and 512-2. Since the splitting ratio of tunable optical splitters 502-1 and 502-3 is 50/50, the optical power at the output of switches 504-3 and 504-4 is maintained at −9 dBm, as shown by reference numbers 512-3 and 512-4.

A further example is shown in FIG. 5C, where tunable optical splitters 502-1 and 502-2 are reconfigured with a 70/30 optical splitting ratio while tunable optical splitter 502-3 is maintained at a 50/50 optical splitting ratio. Under this configuration, the optical loss experienced through the 70% port of tunable optical splitters 502-1 and 502-2 is approximately 1.5 dB, while the loss associated with the 30% port of these same splitters is approximately 5.2 dB. The loss associated with both ports of tunable optical splitter 502-3 is maintained at approximately 3 dB, while the loss associated with each switch 504 remains 3 dB as in previous examples. For an incident optical power of 0 dBm at the input 514, the output power from switch 504-1 is −6 dBm while the output power from switch 504-2 is −9.7 dBm, as shown by reference numbers 516-1 and 516-2. Further, the optical output power from switches 504-3 and 504-4 is −11.2 dBm, as shown by reference numbers 516-3 and 516-4. In this way, programmable multicast switch 500 enables variable attenuation at the output ports, which may address spectral ripple and/or tilt from cascaded amplifiers and/or optical fibers, thereby maintaining the optical power within the dynamic range of receivers connected to the output ports.

Other combinations of optical splitting ratios and corresponding nominal output powers are possible, and may differ from what was described with regard to FIGS. 5A-5C. Although described, herein, in terms of nominal output power to a receiver, tunable optical splitters 502 may be used as combiners to vary a nominal output power from a set of transmitters to an output port of a ROADM.

As indicated above, FIGS. 5A-5C are provided merely as examples. Other examples are possible and may differ from what was described with regard to FIGS. 5A-5C.

A programmable multicast switch can be used to provide dynamically adjustable optical power at drop ports and/or to add ports by controlling the splitting ratio of the tunable optical splitters within the programmable multicast switch. Furthermore, based on permitting selective blocking of connections between tunable optical splitters and switches, the programmable multicast switch may be reconfigured from a single high port count device to multiple smaller port count devices using the same hardware. These configurations may also be combined. For example, a programmable multicast switch may be configured as multiple smaller port count programmable multicast switches with adjustable optical power at add/drop ports.

The foregoing disclosure provides illustration and description, but is not intended to be exhaustive or to limit the implementations to the precise form disclosed. Modifications and variations are possible in light of the above disclosure or may be acquired from practice of the implementations.

As detailed above, although many of the examples have been provided in the context of a programmable multicast switch being configured for splitting optical beams with different split ratios, these examples can be readily understood in a reverse context where the programmable multicast switch combines multiple optical beams with configurable combination ratios. Similarly both of the above examples can be understood as a programmable multicast switch having splitter groups and each splitter group having a plurality of tunable optical dividers where an optical divider may split an incoming beam onto multiple paths and/or combine multiple beams into an outgoing beam in accordance with a tunable splitting ratio.

Even though particular combinations of features are recited in the claims and/or disclosed in the specification, these combinations are not intended to limit the disclosure of possible implementations. In fact, many of these features may be combined in ways not specifically recited in the claims and/or disclosed in the specification. Although each dependent claim listed below may directly depend on only one claim, the disclosure of possible implementations includes each dependent claim in combination with every other claim in the claim set.

No element, act, or instruction used herein should be construed as critical or essential unless explicitly described as such. Also, as used herein, the articles “a” and “an” are intended to include one or more items, and may be used interchangeably with “one or more.” Furthermore, as used herein, the term “set” is intended to include one or more items (e.g., related items, unrelated items, a combination of related items, and unrelated items, etc.), and may be used interchangeably with “one or more.” Where only one item is intended, the term “one” or similar language is used. Also, as used herein, the terms “has,” “have,” “having,” and/or the like are intended to be open-ended terms. Further, the phrase “based on” is intended to mean “based, at least in part, on” unless explicitly stated otherwise.

What is claimed is:

1. An optical divider, comprising:
one or more optical inputs;
a plurality of optical outputs;
a planar lightwave circuit having a plurality of optical splitter groups to split optical beams,
each of the plurality of optical splitter groups connected to an optical input of the one or more optical inputs,
each of the plurality of optical splitter groups including an optically connected cascading arrangement of tunable optical splitters;
a plurality of controllers,
each of the plurality of controllers to adjust an optical splitting ratio of a corresponding tunable optical splitter of the plurality of optical splitter groups; and
a plurality of optical switches to provide optical beam portions of the optical beams for output,
each of the plurality of optical switches connected to each of the plurality of optical splitter groups and connected to an optical output of the plurality of optical outputs.

2. The optical divider of claim 1, further comprising:
a processor to, using control signals sent to the plurality of controllers,
configure a first subset of the plurality of optical splitter groups to provide one or more optical paths to a first subset of the plurality of optical switches and block one or more optical paths to a second subset of the plurality of optical switches, and
configure a second subset of the plurality of optical splitter groups to provide one or more optical paths to the second subset of the plurality of optical switches and block one or more optical paths to the first subset of the plurality of optical switches,
the first subset of the plurality of optical splitter groups being different from the second subset of the plurality of optical splitter groups, and
the first subset of the plurality of optical switches being different from the second subset of the plurality of optical switches.

3. The optical divider of claim 1, further comprising:
a processor to generate a control signal to cause a particular controller of the plurality of controllers to set the optical splitting ratio of the corresponding tunable optical splitter.

4. The optical divider of claim 3, where the optical splitting ratio is set to cause a particular optical path of the corresponding tunable optical splitter to be blocked.

5. The optical divider of claim 1, where the optical splitting ratio of the corresponding tunable optical splitter corresponds to an apportionment of optical power of an optical beam provided as output on different optical paths from the corresponding tunable optical splitter.

6. The optical divider of claim 1, where the cascading arrangement is a K-ary tree arrangement.

7. The optical divider of claim 1, where the optically connected cascading arrangement of tunable optical splitters includes at least one of:
a thermally tunable optical splitter, or
an electrically tunable optical splitter.

8. The optical divider of claim 1, where the planar lightwave circuit further includes the plurality of optical switches.

9. An optical combiner, comprising:
a plurality of optical inputs;
one or more optical outputs;
a planar lightwave circuit having a plurality of optical combiner groups to combine optical beams,
each of the plurality of optical combiner groups connected to an optical output of the one or more optical outputs,
each of the plurality of optical combiner groups including an optically connected cascading arrangement of tunable optical combiners;
a plurality of controllers,
each of the plurality of controllers to adjust an optical combining ratio of a corresponding tunable optical combiner of the plurality of optical combiner groups; and
a plurality of optical switches to receive optical beam portions of the optical beams as input,
each of the plurality of optical switches connected to each of the plurality of optical combiner groups and connected to an optical input of the plurality of optical inputs.

10. The optical combiner of claim 9, further comprising:
a processor to, using control signals sent to the plurality of controllers,
configure a first subset of the plurality of optical combiner groups to provide one or more optical paths from a first subset of the plurality of optical switches and block one or more optical paths from a second subset of the plurality of optical switches, and
configure a second subset of the plurality of optical combiner groups to provide one or more optical paths from the second subset of the plurality of optical switches and block one or more optical paths from the first subset of the plurality of optical switches,
the first subset of the plurality of optical combiner groups being different from the second subset of the plurality of optical combiner groups, and
the first subset of the plurality of optical switches being different from the second subset of the plurality of optical switches.

11. The optical combiner of claim 9, further comprising:
a processor to generate a control signal to cause a particular controller of the plurality of controllers to set a particular optical combining ratio for a corresponding tunable optical combiner.

12. The optical combiner of claim 11, where the optical combining ratio is selected such that an optical path of the corresponding tunable optical combiner is blocked.

13. The optical combiner of claim 9, where the optical combining ratio of the corresponding tunable optical combiner corresponds to an apportionment of optical power of optical beams provided as input on different optical paths to the corresponding tunable optical combiner.

14. The optical combiner of claim 9, where the cascading arrangement is a K-ary tree arrangement.

15. The optical combiner of claim 9, where the optically connected cascading arrangement of tunable optical combiners includes at least one of:
a thermally tunable optical combiner,
an electrically tunable optical combiner,
an acoustically tunable optical combiner, or
a magnetically tunable optical combiner.

16. The optical combiner of claim 9, where the planar lightwave circuit includes the plurality of optical switches.

17. A programmable multicast switch, comprising:
a first set of optical ports;
a second set of optical ports;
a plurality of groups of optical devices optically connected in a cascading arrangement,
at least one optical device in each of the plurality of groups being a tunable optical device,
each group being connected to an optical port of the first set of optical ports;
a plurality of controllers to tune each corresponding tunable optical devices;
a processor to control the plurality of controllers; and
a plurality of optical switches connected to each of the groups of optical devices,
each optical switch of the plurality of optical switches being connected to an optical port of the second set of optical ports.

18. The programmable multicast switch of claim 17, where the processor, using control signals sent to the plurality of controllers, is to:
configure a first subset of the plurality of groups of optical devices to provide one or more optical paths to a first subset of the plurality of optical switches and block one or more optical paths to a second subset of the plurality of optical switches,
configure a second subset of the plurality of groups of optical devices to provide one or more optical paths to the second subset of the plurality of optical switches and block one or more optical paths to the first subset of the plurality of optical switches,
the first subset of the plurality of groups of optical devices being different from the second subset of the plurality of groups of optical devices, and
the first subset of the plurality of optical switches being different from the second subset of the plurality of optical switches.

19. The programmable multicast switch of claim 17, further comprising:
a processor to generate a control signal to cause a particular controller of the plurality of controllers to set an optical splitting ratio of the corresponding tunable optical device.

20. The programmable multicast switch of claim 17, further comprising:
a power monitor to monitor input to a first subset of the plurality of groups of optical devices; and
a photodetector to monitor output from a second subset of the plurality of groups of optical devices.
